(19) United States
(12) Patent Application Publication
(10) Pub. No.: US 2006/0065351 A1
(43) Pub. Date: Mar. 30, 2006

(54) Identification patch

(76) Inventor: Ann Hoenig, Glencoe, IL (US)

Correspondence Address: King & Jovanovic, PLC, 170 College Avenue, SUITE 230, HOLLAND, MI, 49423, US

(21) Appl. No.: 10/955,935

(22) Filed: Sep. 30, 2004

(51) Int. Cl. B32B 37/00; B32B 38/00

(52) U.S. Cl. 156/152; 156/281

(57) ABSTRACT

A method of using the identification apparatus of the present invention comprising the steps of: providing an identification apparatus, applying indicia to the form imprinted surface of the flat planar sheet, affixing the tag to apparel, removing the tag from apparel, washing the surface of the adhesive with water and reaffixing the tag to apparel.

### BACKGROUND OF THE INVENTION

1. Field of the Invention

The present invention relates in general to methods and apparatuses for identifying individuals, and more particularly to methods and apparatuses for identifying an athlete, who generally does not carry any means of identification. Principally, the patch is applyable to clothing, and subsequently removable and reusable by the individual.

2. Background Art

Means for identifying individuals has long been known in the art. For example, identification cards are provided by every state in the union as a means of identifying an individual. Similarly, private organizations provide identification cards to members, employees, suppliers, etc. Such cards, while useful in certain environments, have drawbacks for the athlete.

Generally, an athlete, for example, a runner, may train by running a set number of miles on outdoor trails per week. Runners are very concerned about minimizing weight and bulk of any items that they may require on their runs. Thus, many runners will only take shorts, sox, shoes and perhaps a water bottle on their training runs. Athletic apparel, in general, has no pockets in which to carry an identification card. As a result, runners and other athletes will generally train without having any personal identification. Training without identification can have negative repercussions. In particular, if a runner becomes incapacitated by way of an injury during the training, and, requires medical attention, the runner may be unable to provide any information as to his or her identification. Without identification, the medical team is not able to identify what, if any, medical conditions the runner may have, medications the runner is currently taking, or the medications to which the runner may be allergic. Additionally, the medical team may be unable to contact any family members and inform them of the particular situation of the runner.

Certain identification tags have been developed especially for athletes. However, these solutions suffer from several drawbacks. One such identification tag that has been developed is designed to be attached to shoe laces. The tag comprises an elongated strip of material that includes a snap component at one end, and a mating snap component at the other end. The elongated strip is passed below some of the laces of the shoe and then the components are snapped together so as to trap some of the laces within the inner region of the snapped tag. The elongated strip of material includes regions in which the user can write his or her name, address, telephone number, as well as any other vital information. While the tag can readily accept the necessary information, it is generally difficult to effectively affix to a runners shoe. Specifically, for many runners with narrower shoes there is not enough room to slide the tag under the laces. For others, the flap and movement of the laces during running can be very frustrating and irritating.

Thus, it is an object of the invention to provide a dependable, easy to use and minimally obtrusive identification means for an athlete.

These and other objects will become evident upon review of the appended specification and claim.

### SUMMARY OF THE INVENTION

A method of using the identification apparatus of the present invention comprising the steps of providing an identification apparatus comprising: a tag having a first side and a second side, a flat planar sheet of material having a surface imprinted with a form on the first side of the tag, and an adhesive on the second side for affixing the tag to apparel. The next step is applying indicia to the form imprinted surface of the flat planar sheet, followed by, affixing the tag to apparel, removing the tag from apparel, washing the surface of the adhesive with water, reaffixing the tag to apparel.

In one embodiment, the foregoing steps of affixing, removing, washing, and reaffixing are repeated a multiple of times to the same identification apparatus. In one embodiment, the tag may be replaced on a carrier when it is not in use.

### BRIEF DESCRIPTION OF THE DRAWINGS

FIG. 1 of the drawings is a perspective view of one embodiment of the present identification apparatus;

FIG. 2 of the drawings is a side elevational view of the embodiment of FIG. 1 as applied to apparel; and

FIG. 3 of the drawings is a perspective view of an embodiment of the present identification apparatus positioned on a storage carrier.

### DETAILED DESCRIPTION OF THE INVENTION

While this invention is susceptible to embodiment in many different forms, there is shown in the drawings and will be described below in detail several specific embodiments, with the understanding that the embodiments are to be considered to be an exemplification of the principles of the invention, and the embodiments are not intended to limit the invention to the embodiments illustrated.

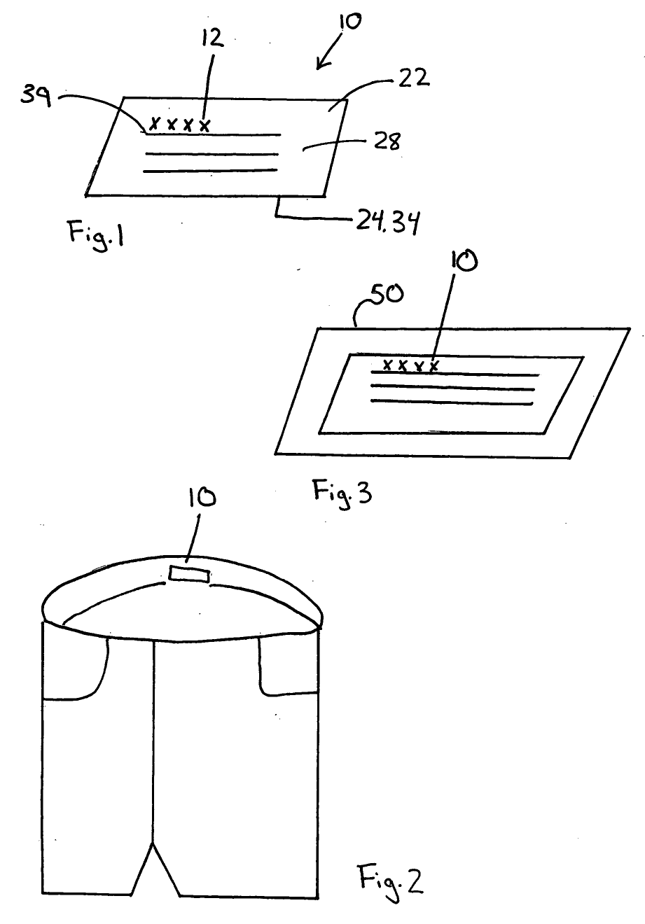

Tag 10 is shown in FIG. 1 as comprising means 22 for accepting indicia and means 24 for attaching to apparel. Tag 10 can be utilized by athletes, such as runners, so as to provide a means for identifying the individual should an accident, or other unfortunate incident result, wherein the individual is not capable of identifying oneself. Tag 10, as shown in FIG. 2 can be positioned on any region of various apparel which is worn by runners. Again, as identified above, the invention and the teachings thereof are not limited to athletes or the sport of running.

Indicia accepting means 22 comprises a substantially flat planar sheet of material having surface 28. Surface 28 may be imprinted with form 39. Form 39 may include multiple identifiers such as NAME, ADDRESS, TELEPHONE, CONTACT NAME, ALLERGIES, MEDICAL CONDITIONS, etc. Next to each identifier, form 39 can provide a space for the user to apply indicia 12. For example, the user can enter the information pertaining to the multiple identifiers. Depending on the size and the space provided to the user, tag 10 may include any number of identifiers, and the identifiers are not limited to those outlined above.

Indicia accepting means 22 may comprise a woven a plastic material. In such an embodiment, the plastic material may accept indicia in the form of a permanent marker or such writing implement. Subsequently, the plastic material is attached to apparel without an additional coating. In such an embodiment, there is no need to utilize a separate plastic protective coating. The material is capable of withstanding a number of washings and repeated uses without significantly disrupting its underlying durability.

Apparel attachment means 24 may comprise a reusable type adhesive 34. Such a reusable adhesive is available from a multitude of different suppliers, but available for substantially different source. The adhesive can be utilized that is reusable for multiple uses. After multiple uses, the adhesive attracts contaminants such as lint, dirt and other objects, at which time the tag is cleaned (for example, by placing the tag under a stream of water). Once cleaned, the adhesive properties of the apparel attachment means 24 are reactivated and the tag is again ready for multiple uses. Of course, depending on the underlying surface to which the tag is attached, the tag may require a greater or lesser frequency of cleaning. In other embodiments, once the adhesive is coated with lint, dirt and other objects, so that it has lost its adhesive properties, the tag can simply be discarded. Crucially, the single adhesive can be reused, thereby reducing the need to purchase and use multiple tags.

In operation, the user first obtains a tag member. Next, the user applies the desired indicia to form 39. For example, the user may write his or her name, address, telephone number, allergies, and known medical problems on surface 28 in the space provided.

Next, the exposes attaching means 24 (which generally comprises an adhesive). Once the adhesive is exposed, and if necessary activated, the user applies the tag to his or her apparel, to, in turn, adhere the tag to the apparel. Now, the user has a means of identification that is releasably adhered to the apparel that minimizes weight, bulk and intrusiveness, but which nevertheless provides information to any necessary individuals as to identification (and in certain circumstances additional medical information), should the athlete become incapacitated.

Once the user completes the exercise, the tag can be removed from the apparel. As the adhesive has been contaminated with outside products, the tag is cleaned with water and prepared for reuse by the user. Advantageously, the user can virtually indefinitely utilize the tag of the present invention only cleaning it when it is contaminated. The tag can be returned to a storage carrier, such as carrier 50, for storage. The carrier 50 is configured to provide releasable adhesion to the adhesive, while minimizing the possibility of contamination of the apparatus. For example, after the user has utilized the tag for a number of uses, the user can wash the tag with water and a mild detergent if necessary. Then the tag can be placed on carrier 50 until it is again required. The carrier can be utilized as a storage location every evening if the tag is utilized daily.

Advantageously, such a system allows for a user to utilize a non-intrusive sticker in place of other “attachable” identification (such as a dog tag, or a permanently attached member), yet permits reuse.

The foregoing description and drawings merely explain and illustrate the invention, and the invention is not limited thereto, as those skilled in the art who have the disclosure before them will be able to make modifications and variations to the system without departing from the scope of the invention.

What is claimed is:

1. A method of using the identification apparatus of the present invention comprising the steps of:
providing an identification apparatus comprising:
a tag having a first side and a second side,
a flat planar sheet of material having a surface imprinted with a form on the first side of the tag, and
an adhesive on the second side for affixing the tag to apparel,
applying indicia to the form imprinted surface of the flat planar sheet;
affixing the tag to apparel;
removing the tag from apparel;
washing the surface of the adhesive with water;
reaffixing the tag to apparel.

2. The method of claim 1 wherein the foregoing steps of affixing, removing, washing, and reaffixing are repeated a multiple of times to the same identification apparatus.

3. The method of claim 1 further comprising the step of placing the tag on a carrier when the tag is not in use.
